(19) United States
(12) Patent Application Publication
(10) Pub. No.: US 2025/0102675 A1
(43) Pub. Date: Mar. 27, 2025

(54) OBJECT DETECTION APPARATUS

(71) Applicant: Honda Motor Co., Ltd., Tokyo (JP)

(72) Inventors: Shunsuke Konishi, Wako-shi (JP); Ryota Okutsu, Tokyo (JP); Hidetoshi Utsumi, Wako-shi (JP); Fumihiro Aoki, Wako-shi (JP); Shuhei Masuoka, Utsunomiya-shi (JP)

(21) Appl. No.: 18/887,151

(22) Filed: Sep. 17, 2024

(30) Foreign Application Priority Data
Sep. 22, 2023 (JP) 2023-158610

(51) Int. Cl. G01S 17/89; G01S 17/931

(52) U.S. Cl. CPC G01S 17/89; G01S 17/931

(57) ABSTRACT

An object detection apparatus includes: a detector configured to irradiate with an electromagnetic wave, to detect an exterior environment situation in the surrounding of a mobile body based on a reflected wave; and a microprocessor configured to perform: acquiring point cloud data, the point cloud data indicating a detection result of the detector; calculating an absolute moving speed of each of a plurality of measurement points corresponding to the point cloud data; classifying the point cloud data into moving point cloud data and stationary point cloud data based on the absolute moving speeds; extracting, from the stationary point cloud data, change point cloud data corresponding to measurement points, a moved amount of which are equal to or larger than a predetermined threshold; and detecting an object in the surrounding of the moving body based on the moving point cloud data and the change point cloud data.

### CROSS-REFERENCE TO RELATED APPLICATION

This application is based upon and claims the benefit of priority from Japanese Patent Application No. 2023-158610 filed on Sep. 22, 2023, the content of which is incorporated herein by reference.

### BACKGROUND

### Technical Field

The present invention relates to an object detection apparatus configured to detect an object in the surroundings of a vehicle.

### Related Art

As this type of device, a device that detects a moving object, by using machine learning from three-dimensional point cloud data that has been acquired by a LiDAR, is known (for example, see JP 2023-027736 A).

However, in the method of using machine learning as the device described in JP 2023-027736 A, the detection accuracy depends on the reliability of the learning model. Hence, the detection accuracy of the moving object may not be sufficiently ensured.

### SUMMARY

An aspect of the present invention is an object detection apparatus including: a detector mounted on a mobile body and configured to irradiate a surrounding of the mobile body with an electromagnetic wave to detect an exterior environment situation in the surrounding of the mobile body based on a reflected wave; and a microprocessor. The microprocessor is configured to perform: acquiring point cloud data for every predetermined period of time, the point cloud data indicating a detection result of the detector, the point cloud data including position information of a measurement point on a surface of an object from which the reflected wave is obtained and first speed information indicating a relative moving speed of the measurement point; acquiring second speed information indicating an absolute moving speed of the mobile body; calculating the absolute moving speed of each of a plurality of measurement points corresponding to the point cloud data, based on the first speed information and the second speed information; classifying the point cloud data into moving point cloud data and stationary point cloud data other than the moving point cloud data, the moving point cloud data corresponding to measurement points where absolute values of the absolute moving speeds are equal to or higher than a predetermined speed; calculating a moved amount for the predetermined period of time of the stationary point cloud data; extracting, from the stationary point cloud data, change point cloud data corresponding to measurement points, the moved amount of which are equal to or larger than a predetermined threshold; and detecting the object in the surrounding of the moving body, based on the moving point cloud data and the change point cloud data.

### BRIEF DESCRIPTION OF DRAWINGS

The objects, features, and advantages of the present invention will become clearer from the following description of embodiments in relation to the attached drawings, in which:

FIG. 1 is is a block diagram illustrating a configuration of a substantial part of a vehicle control apparatus including an object detection apparatus according to the embodiment of the present invention;

FIG. 2 is a diagram for describing a relationship between a relative moving speed of a moving object to be measured by a LiDAR and a moving direction of the moving object;

FIG. 3 is a flowchart illustrating an example of processing to be performed by of the controller in FIG. 1;

FIG. 4 is a diagram schematically illustrating an example of point cloud data acquired by the LiDAR;

FIG. 5A is a diagram schematically illustrating an example of stationary point cloud data of a previous frame;

FIG. 5B is a diagram schematically illustrating an example of stationary point cloud data of current frame;

FIG. 6A is a diagram schematically illustrating a situation in which the stationary point cloud data of the previous frame and the stationary point cloud data of the current frame are aligned with each other;

FIG. 6B is a diagram illustrating the stationary point cloud data of the previous frame and the stationary point cloud data of the current frame after alignment;

FIG. 7 is a diagram schematically illustrating another example of point cloud data acquired by the LiDAR;

FIG. 8 is a diagram illustrating a situation in which a change point is extracted from the stationary point cloud data;

FIG. 9 is a diagram for describing a moving vector of the moving object; and

FIG. 10 is a diagram schematically illustrating an example of information indicating detection result of the moving object.

### DETAILED DESCRIPTION

Hereinafter, embodiments of the present invention will be described with reference to the drawings. An object detection apparatus according to an embodiment of the present invention is applicable to a vehicle having a self-driving capability, that is, a self-driving vehicle. Note that a vehicle to which the object detection apparatus according to the present embodiment is applied will be referred to as a subject vehicle to be distinguished from other vehicles, in some cases. The subject vehicle may be any of an engine vehicle having an internal combustion (engine) as a traveling drive source, an electric vehicle having a traveling motor as the traveling drive source, and a hybrid vehicle having an engine and a traveling motor as the traveling drive source. The subject vehicle is capable of traveling not only in a self-drive mode that does not necessitate the driver's driving operation but also in a manual drive mode of the driver's driving operation.

While a self-driving vehicle is moving in the self-drive mode (hereinafter, referred to as self-driving or autonomous driving), such a self-driving vehicle recognizes an exterior environment situation in the surroundings of the subject vehicle, based on detection data of an in-vehicle detector such as a camera or a light detection and ranging (LiDAR). The self-driving vehicle generates a driving path (a target path) at a predetermined time elapsed after the current time, based on a recognition result, and controls an actuator for driving so that the subject vehicle travels along the target path.

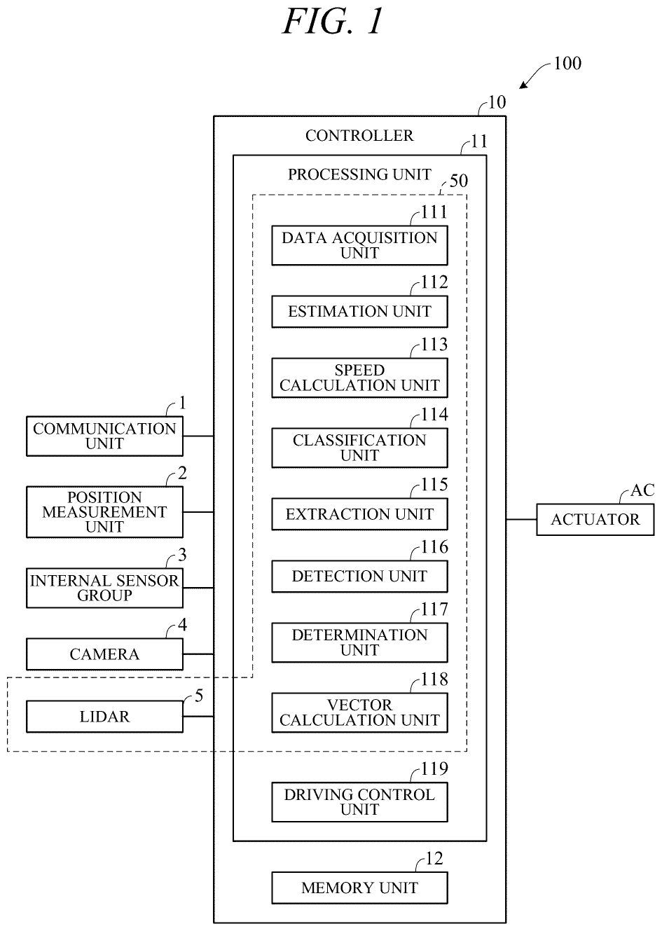

FIG. 1 is a block diagram illustrating a configuration of a substantial part of a vehicle control apparatus 100 including the object detection apparatus. The vehicle control apparatus 100 includes a controller 10, a communication unit 1, a position measurement unit 2, an internal sensor group 3, a camera 4, a LiDAR 5, and a traveling actuator AC. In addition, the vehicle control apparatus 100 includes an object detection apparatus 50, which constitutes a part of the vehicle control apparatus 100. The object detection apparatus 50 detects an object in the surroundings of a vehicle, based on detection data of the LiDAR 5.

The communication unit 1 communicates with various servers, not illustrated, through a network including a wireless communication network represented by the Internet network, a mobile telephone network, or the like, and acquires map information, traveling history information, traffic information, and the like from the servers regularly or at a given timing. The network includes not only a public wireless communication network but also a closed communication network provided for every predetermined management area, for example, a wireless LAN, Wi-Fi (registered trademark), Bluetooth (registered trademark), and the like. The acquired map information is output to a memory unit 12, and the map information is updated. The position measurement unit (GNSS unit) 2 includes a position measurement sensor for receiving a position measurement signal transmitted from a position measurement satellite. The positioning satellite is an artificial satellite such as a GPS satellite or a quasi-zenith satellite. By using the position measurement information that has been received by the position measurement sensor, the position measurement unit 2 measures a current position (latitude, longitude, and altitude) of the subject vehicle.

The internal sensor group 3 is a generic term for a plurality of sensors (internal sensors) that detect a traveling state of the subject vehicle. For example, the internal sensor group 3 includes a vehicle speed sensor that detects the vehicle speed of the subject vehicle, an acceleration sensor that detects the acceleration in a front-rear direction and the acceleration (lateral acceleration) in a left-right direction of the subject vehicle, a rotation speed sensor that detects the rotation speed of the traveling drive source, a yaw rate sensor that detects the rotation angular speed around the vertical axis of the center of gravity of the subject vehicle, and the like. The internal sensor group 3 also includes sensors that detect a driver's driving operation in the manual drive mode, for example, an operation on an accelerator pedal, an operation on a brake pedal, an operation on a steering wheel, and the like.

The camera 4 includes an imaging element such as a CCD or a CMOS, and captures an image of the surroundings of the subject vehicle (a forward side, a rearward side, and lateral sides). The LiDAR 5 irradiates a three-dimensional space in the surroundings of the subject vehicle with an electromagnetic wave (a reflected wave), and detects an exterior environment situation in the surroundings of the subject vehicle, based on the reflected wave. More specifically, the electromagnetic wave (a laser beam or the like) that has been irradiated from the LiDAR 5 is reflected on and returned from a certain point (a measurement point) on the surface of an object, and thus the distance from the laser source to such a point, the intensity of the electromagnetic wave that has been reflected and returned, the relative speed of the object located at the measurement point, and the like are measured. The electromagnetic wave of the LiDAR 5, which is attached to a predetermined position (a front part) of the subject vehicle is scanned in a horizontal direction and a vertical direction with respect to the surroundings (a forward side) of the subject vehicle. Thus, the position, the shape, the relative moving speed, and the like of an object (a moving object such as another vehicle or a stationary object such as a road surface or a structure) on a forward side of the subject vehicle are detected. Note that hereinafter, the above three-dimensional space will be represented by an X axis along an advancing direction of the subject vehicle, a Y axis along a vehicle width direction of the subject vehicle, and a Z axis along a height direction of the subject vehicle. Therefore, the above three-dimensional space will be referred to as an XYZ space, in some cases.

The actuator AC is a traveling actuator for controlling traveling of the subject vehicle. In a case where the traveling drive source is an engine, the actuators AC include a throttle actuator that adjusts an opening (throttle opening) of a throttle valve of the engine. In a case where the traveling drive source is a traveling motor, the actuators AC includes the traveling motor. The actuator AC also includes a brake actuator that operates a braking device of the subject vehicle and a steering actuator that drives the steering device.

The controller 10 includes an electronic control unit (ECU). More specifically, the controller 10 is configured to include a computer including a processing unit 11 such as a CPU (microprocessor), the memory unit 12 such as a ROM and a RAM, and other peripheral circuits (not illustrated) such as an I/O interface. Note that a plurality of ECUs having different functions such as an engine control ECU, a traveling motor control ECU, and a braking device ECU can be separately provided, but in FIG. 1, the controller 10 is illustrated as an aggregation of these ECUs as a matter of convenience.

The memory unit 12 stores highly precise detailed map information (referred to as high-precision map information). The high-precision map information includes position information of roads, information of road shapes (curvatures or the like), information of road gradients, position information of intersections and branch points, information of the number of traffic lanes (traveling lanes), information of traffic lane widths and position information for every traffic lane (information of center positions of traffic lanes or boundary lines of traffic lane positions), position information of landmarks (traffic lights, traffic signs, buildings, and the like) as marks on a map, and information of road surface profiles such as irregularities of road surfaces. In addition, the memory unit 12 stores programs for various types of control, information such as a threshold for use in a program, and setting information for the in-vehicle detection unit such as the LiDAR 5.

The processing unit 11 includes, as a functional configuration, a data acquisition unit 111, an estimation unit 112, a speed calculation unit (hereinafter, simply referred to as a calculation unit) 113, a classification unit 114, a extraction unit 115, a detection unit 116, a determination unit 117, a vector calculation unit 118 and a driving control unit 119. Note that as illustrated in FIG. 1, the data acquisition unit 111, the estimation unit 112, the speed calculation unit 113, the classification unit 114, the extraction unit 115, the detection unit 116, the determination unit 117, and the vector calculation unit 118 are included in the object detection apparatus 50. Details of the data acquisition unit 111, the estimation unit 112, the speed calculation unit 113, the classification unit 114, the extraction unit 115, the detection unit 116, the determination unit 117, and the vector calculation unit 118 included in the object detection apparatus 50 will be described later.

In the self-drive mode, the driving control unit 119 generates a target path, based on an exterior environment situation in the surroundings of the vehicle, including a size, a position, a relative moving speed, and the like of an object that has been detected by the object detection apparatus 50. Specifically, the driving control unit 119 generates the target path to avoid collision or contact with the object or to follow the object, based on the size, the position, the relative moving speed, and the like of the object that has been detected by the object detection apparatus 50. The driving control unit 119 controls the actuator AC so that the subject vehicle travels along the target path. Specifically, the driving control unit 119 controls the actuator AC along the target path to adjust an accelerator opening or to actuate a braking device or a steering device. Note that in the manual drive mode, the driving control unit 119 controls the actuator AC in accordance with a traveling command (a steering operation or the like) from the driver that has been acquired by the internal sensor group 3.

Details of the object detection apparatus 50 will be described. As described above, the object detection apparatus 50 includes the data acquisition unit 111, the estimation unit 112, the speed calculation unit 113, the classification unit 114, the extraction unit 115, the detection unit 116, the determination unit 117 and the vector calculation unit 118. The object detection apparatus 50 further includes the LiDAR 5.

The data acquisition unit 111 acquires, as detection data of the LiDAR 5, four-dimensional data (hereinafter, referred to as point cloud data) including position information indicating three-dimensional position coordinates of a measurement point on a surface of the object from which the reflected wave of the LiDAR 5 is obtained, and speed information indicating a relative moving speed of the measurement point. The point cloud data is acquired by the LiDAR 5 in units of frames, specifically, at a predetermined time interval (a time interval determined by a frame rate of the LiDAR 5).

As a method for detecting the moving object from detection data (point cloud data) of the LiDAR 5, there is a method for performing clustering processing on the point cloud data and classifying the point cloud data into measurement points corresponding to the moving object and the other measurement points, and detecting the moving object. However, the point cloud data also includes information of the measurement points corresponding to a stationary object. For this reason, in a case where the point cloud data that has been acquired from the LiDAR 5 is used without change for the clustering processing, not only the measurement point cloud corresponding to the moving object but also the measurement point cloud corresponding to the stationary object is to be classified. Thus, a calculation load in the clustering processing may increase. Hence, in order to reduce the calculation load, there is a conceivable method for converting a relative moving speed indicated by speed information of each measurement point into an absolute speed (hereinafter, referred to as an absolute moving speed), classifying the point cloud data into stationary point cloud data corresponding to a stationary object and moving point cloud data corresponding to a moving object, based on the absolute moving speed, and performing the clustering processing on the moving point cloud data that has been classified.

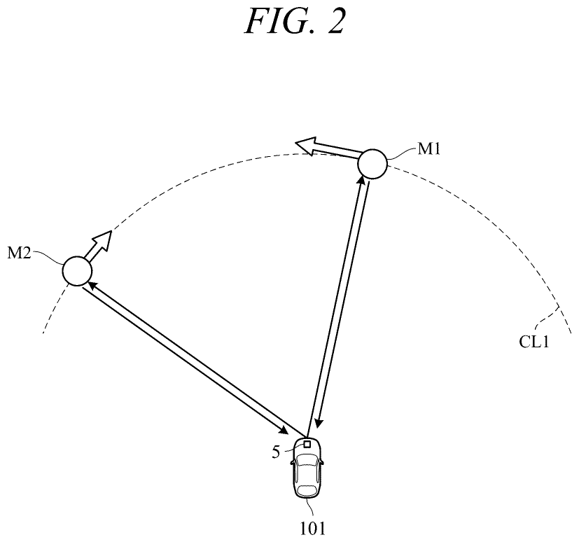

Depending on the moving direction of the moving object, however, the LiDAR 5 is not capable of measuring the relative moving speed, in some cases. FIG. 2 is a diagram for describing a relationship between the relative moving speed of a moving object to be measured by the LiDAR 5 and a moving direction of the moving object. In FIG. 2, a white arrow line represents a situation in which each of moving objects M1 and M2 moves in each direction of such an arrow. A solid arrow line schematically represents a situation in which the electromagnetic wave is irradiated by the LiDAR 5, is reflected on a surface of each of the moving objects M1 and M2, and is then returned. A broken line CL1 is an imaginary line that connects points equal in distance to each other from the LiDAR 5, which is mounted on the subject vehicle 101.

The LiDAR 5 is not capable of detecting the speed in the vertical direction with respect to a light irradiation angle. Therefore, when the moving objects M1 and M2 move on the broken line CL1 as illustrated in FIG. 2, their moving direction is perpendicular to the light irradiation angle of the LiDAR 5, so the relative moving speeds of the moving objects M1 and M2 to be measured by the LiDAR 5 remain zero, and do not change. As a result, the moving objects M1 and M2 are each detected as a stationary object, instead of a moving object, and the measurement points respectively corresponding to the moving objects M1 and M2 are classified into the stationary point cloud data. Therefore, in the method for performing the clustering processing only on the moving point cloud data, the moving objects M1 and M2, which move in the vertical direction with respect to the light irradiation angle of the LiDAR 5, may be excluded from the target of the clustering processing. In this case, the moving objects M1 and M2 are lost in sight, and the moving objects M1 and M2 cannot be accurately tracked. Hence, in the present embodiment, the clustering processing is performed on the point cloud data as follows, so that it becomes possible to accurately detect a moving object, while reducing a calculation load.

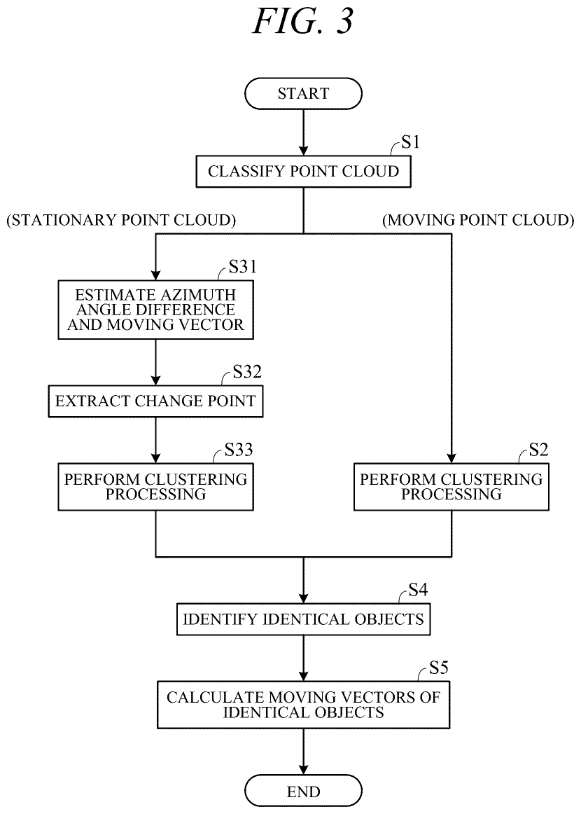

FIG. 3 is a flowchart illustrating an example of processing to be performed by the CPU of the controller 10 in FIG. 1, in accordance with a predetermined program. The processing illustrated in this flowchart is repeated at a predetermined cycle, while the object detection apparatus 50 is running. More specifically, the processing is repeated whenever the detection data of the LiDAR 5 is acquired by the data acquisition unit 111, that is, every predetermined time.

When the detection data (point cloud data) of the LiDAR 5 is acquired, first, processing (step S1) of classifying the point cloud data into the moving point cloud data and the stationary point cloud data is performed. Next, detection processing (step S2) of the moving object with respect to moving point cloud data and detection processing (steps S31 to S33) of the moving object with respect to stationary point cloud data are performed in parallel. Note that the detection processing (step S2) and the detection processing (steps S31 to S33) may not be necessarily performed in parallel. After either one of them is performed, the other one may be performed. Next, on the moving object that has been detected, processing of identifying identical objects between frames (between a current frame and a previous frame) (step S4) is performed, and finally, processing of calculating moving vectors of the moving objects that have been identified as the identical objects (step S5) is performed.

In the detection processing of the moving object with respect to the moving point cloud data (step S2), clustering processing is performed on the moving point cloud data. In processing of detecting the moving object with respect to the stationary point cloud data (steps S31 to S33), first, in step S31, predetermined scan matching processing is performed to superimpose the stationary point cloud data of the previous frame on the stationary point cloud data of the current frame, and an azimuth angle difference and the moving vector of the subject vehicle 101 are estimated. The moving vector represents a moving direction of a representative point (such as a center of gravity) of the subject vehicle 101 between the frames and a moving speed in such a moving direction. The azimuth angle difference is an angle difference of an azimuth (advancing direction) in the current frame with respect to the azimuth in the previous frame of the subject vehicle 101. Hereinafter, an X axis is defined as an axis along the advancing direction of the moving body, and a Y axis and Z axis are respectively defined as a lateral direction and a height direction with respect to the advancing direction. Note that the moving vector may be in two dimension (X, Y) or three dimension (X, Y, Z). In addition, the azimuth angle difference may be a one-axis angle (Z-axis rotation angle), a two-axis angle (X-axis rotation angle and Z-axis rotation angle), or a three-axis angle (X-axis rotation angle, Y-axis rotation angle, and Z-axis rotation angle). For the scan matching processing, iterative closest point (ICP) or normal distributions transform (NDT) may be used, or any other method may be used. Next, in step S32, a change point is extracted, based on a result of superimposing the stationary point cloud data of the previous frame and the stationary point cloud data of the current frame in the scan matching processing in step S31. Specifically, a distance difference value between each measurement point of the previous frame and each measurement point of the current frame that correspond to each other in the superimposition is calculated, and a measurement point, the distance difference value of which is equal to or larger than a predetermined threshold, is extracted as the change point. Finally, in step S33, the clustering processing is performed on the measurement point cloud that has been extracted (change point cloud). Note that the azimuth angle difference and the moving vector of the subject vehicle 101 estimated in step S31 are accumulated, and self-position estimation processing (not illustrated) for estimating the self-position (the traveling position of the subject vehicle 101) is performed, based on the azimuth angle difference and the moving vector that have been accumulated.

The processing in each step of FIG. 3 will be described in detail.

### Classification of Point Cloud (S1)

The estimation unit 112 estimates an absolute moving speed (a speed vector in X, Y, Z coordinates) of the subject vehicle 101, based on the point cloud data that has been acquired by the data acquisition unit 111. Here, estimation of the absolute moving speed of the subject vehicle 101 by the estimation unit 112 will be described.

First, the estimation unit 112 extracts point cloud data obtained by removing information of measurement points corresponding to a three-dimensional object from the point cloud data that has been acquired by the data acquisition unit 111, that is, point cloud data corresponding to a road surface (hereinafter, referred to as road surface point cloud data) in the surroundings of the subject vehicle. The estimation unit 112 calculates, in the following equation (i), a unit vector ei indicating the direction of a relative moving speed vi, based on the road surface point cloud data, that is, position coordinates (xi, yi, zi) included in four-dimensional data (xi, yi, zi, vi) of the measurement points Pi (i=1, 2, . . . , n) corresponding to the road surface.

$${e}_{i} = \frac{( {x}_{i} , {y}_{i} , {z}_{i} )}{‖ {x}_{i} , {y}_{i} , {z}_{i} ‖} = ( {x}_{ei} , {y}_{ei} , {z}_{e i} ) \qquad Equation ( i )$$

Next, the estimation unit 112 estimates the moving speed (the absolute moving speed) Vself of the subject vehicle. Specifically, the estimation unit 112 sets a conversion formula for converting the relative moving speed vi of the measurement point Pi corresponding to the road surface into the absolute moving speed, as an objective function L, and solves an optimization problem for optimizing the objective function L to be closer to zero. The measurement point Pi is a measurement point on a road surface, and thus the absolute speed of each measurement point must be zero. Therefore, by optimizing the objective function L to be closer to zero, it becomes possible to estimate Vself that is correct. Vself is represented by speed components in XYZ-axis directions as indicated in the following equation (ii). The objective function L is expressed by the following equation (iii). By solving the above optimization problem, Vself that makes the right side of equation (iii) zero is searched for. Note that zero may be set to Vself as an initial value, or Vself that has been estimated in a previous frame may be set.

$${V}_{self} = ( {v}_{x} , {v}_{y} , {v}_{z} ) \qquad Equation ( ii )$$

$$L ( V , f ( A , {V}_{self} ) ) = V + A \cdot {V}_{self}^{T} \qquad Equation ( iii )$$

In the equation (iii), A denotes a matrix of unit vectors ei of n measurement points corresponding to the road surface, and is expressed by a equation (iv). In addition, in the equation (iii), V denotes a matrix of 1×n representing speed components (the relative moving speeds) of n measurement points Pi corresponding to the road surface, and is expressed by a equation (v). The estimation unit 112 acquires Vself obtained by solving the above optimization problem, as an estimated value of the absolute moving speed of the subject vehicle in a current frame.

$$A = {[ {e}_{1} , {e}_{2} , … , {e}_{n} ]}^{T} = [ \begin{matrix}{x}_{e 1} & {y}_{e 1} & {z}_{e 1} \\ {x}_{e 2} & {y}_{e 2} & {z}_{e 2} \\ ⋮ & ⋮ & ⋮ \\ {x}_{e n} & {y}_{e n} & {z}_{e n}\end{matrix} ] \qquad Equation ( iv )$$

$$V = {[ {v}_{1} , {v}_{2} , … , {v}_{n} ]}^{T} \qquad Equation ( v )$$

The speed calculation unit 113 calculates the absolute moving speeds of all measurement points, more specifically, all measurement points including the measurement points corresponding to the three-dimensional object, based on the absolute moving speed Vself of the subject vehicle that has been estimated by the estimation unit 112. Here, the absolute moving speed that has been calculated has a negative value when approaching the subject vehicle, and has a positive value when leaving the subject vehicle.

The classification unit 114 classifies the point cloud data that has been acquired by the data acquisition unit 111 into moving point cloud data corresponding to the measurement point at which the absolute value of the absolute moving speed that has been calculated by the speed calculation unit 113 is equal to or higher than a predetermined speed Th_V and stationary point cloud data corresponding to the measurement point at which the absolute value is lower than the predetermined speed Th_V.

### Estimation of Moving Vector (S31)

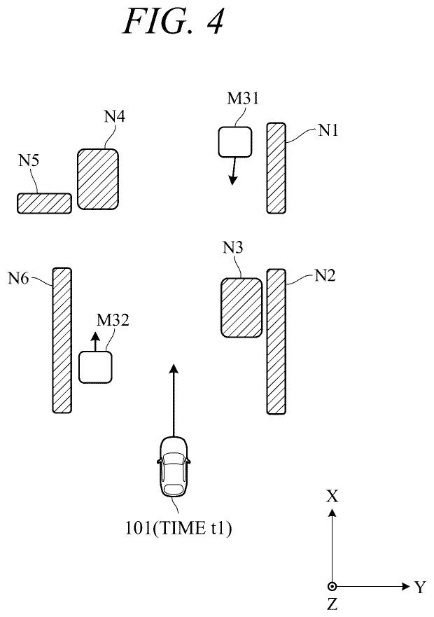

FIGS. 4, 5A, 5B, 6A, and 6B are each a diagram for describing processing of estimating a moving vector and an azimuth angle of the subject vehicle 101 between frames (step S31). In FIG. 4, an arrow applied to the subject vehicle 101 indicates a moving direction (an advancing direction) of the subject vehicle 101, that is, the X-axis direction. In addition, a lateral direction (a left-right direction in FIG. 4) and a height direction (a direction from the depth side to the near side in FIG. 4) with respect to the X-axis direction respectively represent the Y-axis direction and the Z-axis direction. Note that because the definitions of the X-axis direction, Y-axis direction, and Z-axis direction are also similar in the other drawings, representations of the X-axis, Y-axis, and Z-axis are omitted in such drawings. FIG. 4 illustrates an example of a schematic diagram when the point cloud data that has been acquired by the LiDAR 5 at a past time (time t1) is viewed from a top surface (Z-axis direction). Regions N1 to N6 schematically represent the measurement point cloud corresponding to the stationary object, more specifically, the position and the size of the measurement point cloud. The stationary object includes a road surface of a road on which the subject vehicle 101 is traveling, a structure such as a wall or a separation zone installed on a lateral side of the road, other vehicles parked on a road shoulder, and the like. Regions M31 and M32 schematically represent the measurement point cloud corresponding to the moving object, more specifically, the position and the size of the measurement point cloud. Note that hereinafter, a target object to be detected by the LiDAR 5 will be referred to as an object including a person. Therefore, a moving object includes a moving person (a pedestrian or the like), in addition to a moving vehicle such as an automobile or a bicycle. Arrows applied to the regions M31 and M32 respectively indicate the moving directions of the moving objects.

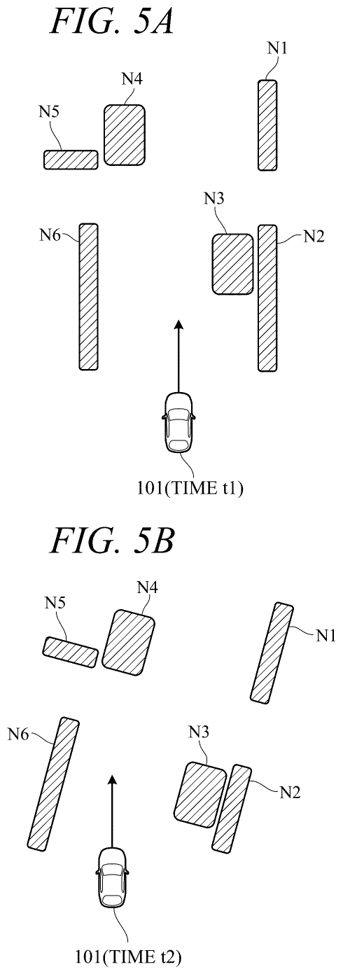

FIG. 5A schematically illustrates the point cloud data of FIG. 4, that is, the stationary point cloud data that has been classified from the point cloud data acquired by the LiDAR 5 at the past time (time t1). FIG. 5B schematically illustrates the stationary point cloud data that has been classified from the point cloud data acquired by the LiDAR 5 at a current time (time t2), when a predetermined period of time has elapsed from the predetermined past time (time t1).

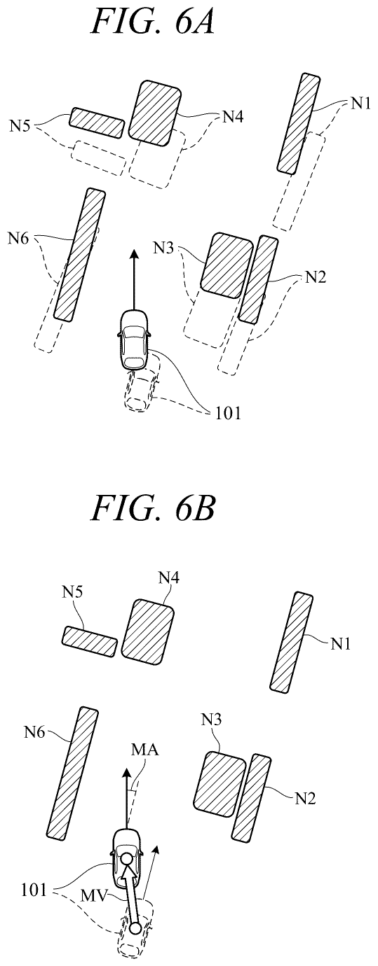

The estimation unit 112 first aligns the stationary point cloud data of the previous frame (FIG. 5A) with the stationary point cloud data of the current frame (FIG. 5B), and estimates the azimuth angle difference and the moving vector of the subject vehicle 101 in a predetermined period of time (between the frames). FIGS. 6A and 6B schematically illustrate a situation in which the stationary point cloud data of the previous frame (FIG. 5A) and the stationary point cloud data of the current frame (FIG. 5B) are aligned with each other. In FIG. 6A, the stationary point cloud data of the previous frame is indicated by broken lines, and the stationary point cloud data of the current frame is indicated by solid lines. The estimation unit 112 searches for (estimates) the azimuth angle difference and the moving vector of the subject vehicle 101 so that the measurement point clouds N1 to N6 of the previous frame indicated by the broken lines respectively superimpose (match) the measurement point clouds N1 to N6 of the current frame indicated by the solid lines. FIG. 6B illustrates the stationary point cloud data of the previous frame and the stationary point cloud data of the current frame after alignment. In FIG. 6B, an angle MA represents the azimuth angle difference of the subject vehicle 101 between the frames. A white arrow MV represents a moving vector of the subject vehicle 101 between the frames. A white circle in the drawing schematically represents the center of gravity of the subject vehicle 101. The estimation unit 112 solves an optimization problem that minimizes a deviation (error) between the positions of the measurement point clouds N1 to N6 in the previous frame and the positions of the measurement point clouds N1 to N6 in the current frame after alignment, and outputs a final search result (an estimation result) of the azimuth angle difference and the moving vector of the subject vehicle 101. Note that in order to reduce the calculation load, after the three-dimensional point cloud data is converted into two-dimensional point cloud data represented in an XY coordinate system, the above alignment may be performed.

### Extraction of Change Point (S32)

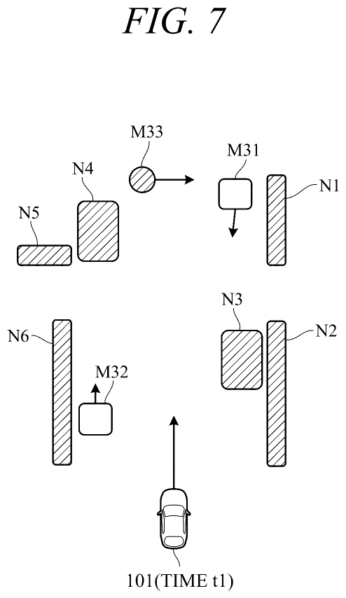

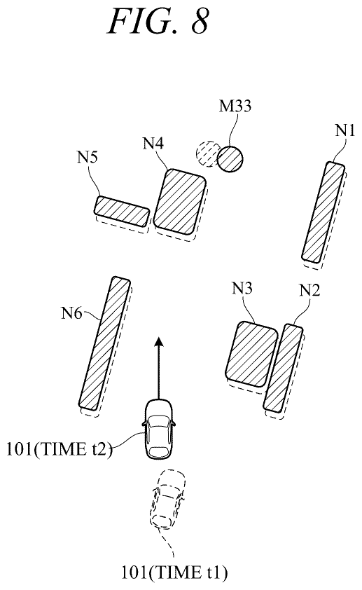

FIGS. 7 and 8 are diagrams for describing extraction processing of a change point (step S32). FIG. 7 illustrates another example of the schematic diagram when the point cloud data acquired by the LiDAR 5 at the past time (time t1) is viewed from the top surface (Z-axis direction). The point cloud data illustrated in FIG. 7 is similar to the point cloud data illustrated in FIG. 4, but the point cloud data illustrated in FIG. 7 includes a measurement point cloud (a region M33) corresponding to the moving object that moves in the vertical direction with respect to the light irradiation angle of the LiDAR 5. In FIG. 7, shaded regions respectively represent the measurement point clouds that have been classified as the stationary point cloud data. As described above, the LiDAR 5 is not capable of detecting the speed in a direction perpendicular to the light irradiation angle. Thus, as illustrated in FIG. 7, an object corresponding to the region M33 is erroneously detected as a stationary object, instead of a moving object. Hence, the extraction unit 115 calculates a change amount (a moved amount) of the position between the frames (a predetermined period of time) of each measurement point of the stationary point cloud data, and also extracts, as a change point, a measurement point, the change amount of which is equal to or larger than a predetermined threshold, so that the object corresponding to the region M33 is detected as the moving object. FIG. 8 illustrates a situation in which the change point is extracted from the stationary point cloud data. In FIG. 8, the stationary point cloud data (FIG. 7) of the previous frame is indicated by broken lines, and the stationary point cloud data of the current frame is indicated by solid lines. FIG. 8 illustrates a situation in which the point cloud data of the previous frame is aligned with the point cloud data of the current frame with use of the moving vector and the azimuth angle difference of the subject vehicle that have been estimated by the estimation unit 112. As illustrated in FIG. 8, the position of the measurement point cloud M33, which corresponds to the moving object, but erroneously detected as the stationary object, greatly changes between the frames, as compared with the other measurement point clouds N1 to N6. Therefore, each measurement point of the measurement point cloud M33 is extracted as a change point by the extraction unit 115. Hereinafter, the point cloud data corresponding to the change point (change point cloud) that has been extracted by the extraction unit 115 will be referred to as change point cloud data.

### Clustering Processing (S2, S33)

In step S2, the detection unit 116 performs the clustering processing on the moving point cloud data (the moving point cloud data classified from the point cloud data of the current frame in step S1). In addition, in step S33, the detection unit 116 performs the clustering processing on the change point cloud data extracted from the stationary point cloud data (the stationary point cloud data classified from the point cloud data of the current frame in step S1). Accordingly, a bounding box (a circumscribed region) corresponding to each of the measurement point clouds M31 and M32 is detected from the moving point cloud data, and a bounding box corresponding to the measurement point cloud M33 is detected from the change point cloud data. The detection unit 116 detects the position and the size of the bounding box that has been detected, as the position and the size of the moving object. In this manner, a moving object included in a three-dimensional space in the surroundings of the subject vehicle 101 is detected. The detection unit 116 outputs information (image information or the like) indicating a detection result of the moving object on a display device, not illustrated, or the like. Note that any method such as density-based spatial clustering of applications with noise (DBSCAN) or K-means clustering may be used for the clustering processing by the detection unit 116.

### Identification of Identical Object (S4)

The determination unit 117 determines whether the moving object that has been detected from the previous frame and the moving object that has been detected from the current frame are identical objects.

Specifically, first, the determination unit 117 performs offset rotation processing of offsetting (a parallel movement) and rotating each bounding box that has been detected in the clustering processing by the detection unit 116 in the previous frame, based on the moving vector and the azimuth angle difference of the subject vehicle 101 between the frames estimated in step S31. In the offset rotation processing, the determination unit 117 first offsets each bounding box that has been detected in the previous frame in accordance with the above moving vector, and rotates each bounding box by the above azimuth angle difference. Next, the determination unit 117 further offsets each bounding box that has been offset and rotated, based on the moving vector of the corresponding moving object. Specifically, the bounding boxes of the measurement point clouds M31, M32, and M33 are further offset by the moved amount obtained by multiplying the vector amount of the moving vector of the moving object corresponding to the measurement point clouds M31, M32, and M33 by a frame period of time (a predetermined period of time). The moving vector of the moving object will be described later.

As described above, the determination unit 117 superimposes, on the current frame, each of the bounding boxes of the previous frame that having been obtained by the offset rotation processing based on the moving vector and the azimuth angle difference of the subject vehicle 101 and the offset processing based on the moving vector of the moving object. As a result of the superimposition, in a case where a bounding box is present in the current frame to be overlapped on the bounding box of the previous frame that has been obtained by the offset rotation processing and the offset processing, the determination unit 117 determines that the moving objects respectively corresponding to the superimposed bounding boxes are the identical objects. Note that the determination as to whether the bounding boxes are overlapped on each other may be made, based on whether their overlap ratio is equal to or larger than a predetermined threshold, or may be made, based on whether the distance between the centers of gravity of the bounding boxes is shorter than a predetermined length.

### Calculation of Moving Vector (S5)

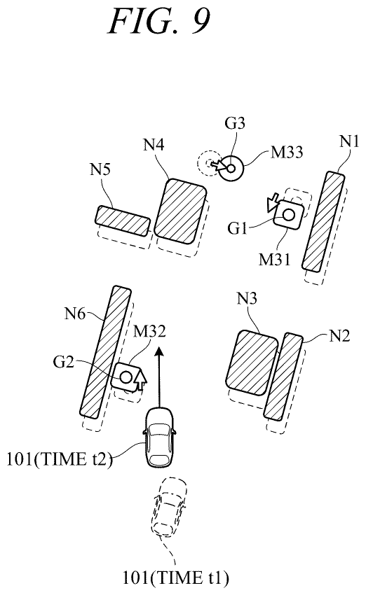

The vector calculation unit 118 calculates a moving vector of the moving object, based on a determination result of the determination unit 117. The calculation of the moving vector of the moving object will be described with reference to FIG. 9. FIG. 9 is a diagram for describing the moving vector of the moving object. In FIG. 9, the point cloud data of the previous frame is indicated by broken lines, and the point cloud data of the current frame is indicated by solid lines. FIG. 9 illustrates a situation in which the point cloud data of the previous frame that has been obtained by the offset rotation processing based on the moving vector and the azimuth angle difference of the subject vehicle 101 is superimposed on the point cloud data of the current frame. White circles G1, G2, and G3 respectively represent the centers of gravity of the measurement point clouds M31, M32, and M33, more specifically, the centers of gravity of the bounding boxes of the measurement point clouds M31, M32, and M33 that have been detected in the clustering processing by the detection unit 116. The vector calculation unit 118 calculates the moving vectors of the moving objects respectively corresponding to the measurement point clouds M31, M32, and M33, based on a positional relationship among the centers of gravity G1, G2, and G3 (between the previous frame and the current frame). The vector calculation unit 118 stores the moving vector of the moving object that has been calculated, in the memory unit 12, together with information (an identifier) with which the moving object is identifiable. The moving vector of the moving object stored in the memory unit 12 is used in the offset processing based on the moving vector of the moving object next time, that is, the offset processing in step S4 to be performed on the next frame. This enables accurate identification of the identical objects in the next frame, and the position, the moving direction, and the moving speed of the moving object can be satisfactorily tracked.

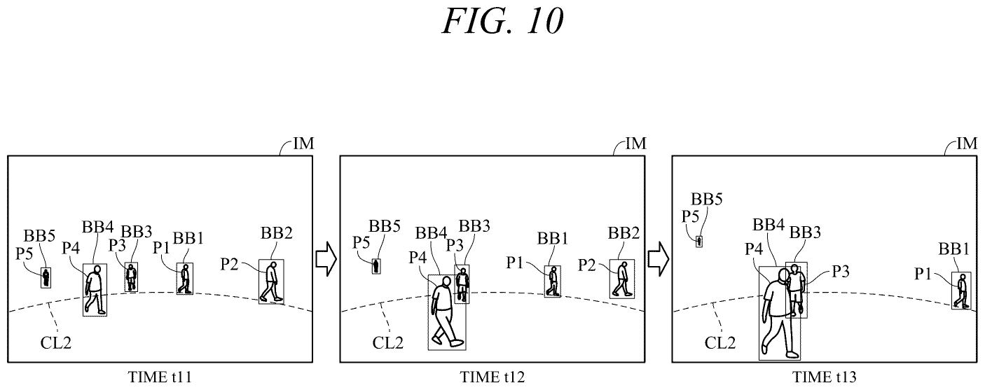

FIG. 10 is a diagram illustrating an example of information indicating detection results of the moving objects to be output by the detection unit 116. Note that FIG. 10 illustrates, as information indicating the detection results of the moving objects, image information in which bounding boxes BB1 to BB5 of the moving objects (pedestrians P1 to P5 who are moving in different directions from one another) that have been detected in the clustering processing by the detection unit 116 are superimposed on a captured image IM, which has been acquired by the camera 4. The captured image IM of the camera 4 includes stationary objects such as a building, in addition to the pedestrians P1 to P5. However, in FIG. 10, in order to simplify the drawing, they are omitted in the drawing. Note that instead of the captured image IM of the camera 4, image information obtained by superimposing the bounding boxes of the moving objects on the image indicating the detection data of the LiDAR 5 may be output as the information indicating the detection results of the moving objects.

FIG. 10 illustrates the detection results of the moving objects from time t11 to time t13. A broken line CL2 in the drawing is an imaginary line that connect points equal in distance to each other from the LiDAR 5. The broken line CL2 is given for description, and is not actually included in the detection results of the moving objects. In the present embodiment, as described above, the clustering processing is also performed on the change point cloud data that has been extracted from the stationary point cloud data. Therefore, it becomes possible to track the moving object in the surroundings of the subject vehicle 101 including the moving object moving perpendicularly to the light irradiation angle of the LiDAR 5, such as the pedestrian P1 in FIG. 10, without losing sight of the moving object.

According to the embodiments described above, the following operations and effects are obtained.

(1) The object detection apparatus 50 includes: the LiDAR 5, which is mounted on the subject vehicle 101, which irradiates the surroundings of the subject vehicle 101 with an electromagnetic wave, and which detects an exterior environment situation in the surroundings of a moving body, based on a reflected wave; the data acquisition unit 111, which acquires point cloud data for every predetermined period of time, the point cloud data indicating a detection result of the LiDAR 5, the point cloud data including position information of a measurement point on a surface of an object from which the reflected wave is obtained and speed information (referred to as first speed information) indicating a relative moving speed of the measurement point; the estimation unit 112, which acquires speed information (referred to as second speed information) indicating an absolute moving speed of the subject vehicle 101; the speed calculation unit 113, which calculates the absolute moving speed of each of a plurality of measurement points corresponding to the point cloud data, based on first speed information and second speed information; the classification unit 114, which classifies the point cloud data into moving point cloud data and stationary point cloud data other than the moving point cloud data, the moving point cloud data corresponding to a measurement point at which an absolute value of the absolute moving speed that has been calculated by the speed calculation unit 113 is equal to or higher than a predetermined speed; the extraction unit 115, which calculates a moved amount for a predetermined period of time of the stationary point cloud data, and which extracts, from the stationary point cloud data, change point cloud data corresponding to a measurement point, the moved amount of which is equal to or larger than a predetermined threshold; and the detection unit 116, which detects the moving object in the surroundings of the moving body, based on the moving point cloud data and the change point cloud data. The detection unit 116 performs predetermined clustering processing on the moving point cloud data and the change point cloud data, detects a circumscribed region of the object from each the moving point cloud data and the change point cloud data, and detects the position and the size of the object, based on the position and the size of the circumscribed region. Accordingly, it becomes possible to accurately detect the moving object, while reducing a processing load. In addition, it becomes also possible to accurately detect the moving object that moves in a direction perpendicular to the light irradiation angle of the LiDAR 5.

(2) The object detection apparatus 50 includes: the estimation unit 112, which serves as an information acquisition unit that acquires first moving information indicating a moving state of the subject vehicle 101 from a past time to a current time, based on the stationary point cloud data at the current time and the stationary point cloud data at the past time that is before the current time; the memory unit 12, which stores second moving information indicating a moving state of the moving object from the past time to the current time; the determination unit 117, which makes alignment of a circumscribed region (a first circumscribed region) that has been detected by the detection unit 116 from the moving point cloud data and the change point cloud data at the past time, based on the first moving information that has been acquired by the estimation unit 112 and the second moving information stored in the memory unit 12 to be superimposed on a circumscribed region (a second circumscribed region) that has been detected by the detection unit 116 from the moving point cloud data and the change point cloud data at the current time, and which determines whether the moving object corresponding to the first circumscribed region and the moving object corresponding to the second circumscribed region are identical objects, based on an overlap degree between the first circumscribed region and the second circumscribed region after the alignment; and the vector calculation unit 118, which serves as an update unit that updates the second moving information, based on positions of the first circumscribed region and the second circumscribed region, the second moving information being stored in the memory unit 12 and corresponding to the moving objects that have been determined to be the identical objects by the determination unit 117. Accordingly, also in a case where a moving object moving in a direction perpendicular to the light irradiation angle of the LiDAR 5 is included in the moving objects in the surroundings of the subject vehicle 101, it becomes possible to accurately track the moving object in the surroundings of the subject vehicle 101 without losing sight of the moving object.

(3) The estimation unit 112 estimates the absolute moving speed of the subject vehicle 101, based on the position information and the speed information of a representative measurement point that has been extracted from the point cloud data acquired by the data acquisition unit 111, and acquires an estimation result as the speed information. The representative measurement point is selected from remaining measurement points excluding the measurement points corresponding to a three-dimensional object from the plurality of measurement points. Accordingly, the absolute moving speed of the subject vehicle 101 is estimated with reference to the measurement point corresponding to the road surface. As a result, the absolute moving speed of the subject vehicle 101 can be accurately estimated. In addition, the absolute moving speed of the subject vehicle (the moving body) 101 is estimated and acquired, regardless of a sensor value of a vehicle speed sensor or the like. Therefore, the present invention is applicable to a self-propelled robot or the like that does not include the vehicle speed sensor or the like.

The above embodiment can be modified into various forms. Hereinafter, modifications will be described. In the above embodiment, the LiDAR 5 as a detector is mounted on the vehicle, irradiates the three-dimensional space in the surroundings of the vehicle with the electromagnetic wave, and detects the exterior environment situation in the surroundings of the vehicle, based on the reflected wave. However, the detector may be a radar or the like, instead of the LiDAR. In addition, the moving body in which the detector is mounted may be a self-propelled robot, instead of the vehicle.

In addition, in the above embodiment, the estimation unit 112, which serves as the speed acquisition unit, selects the measurement point Pi as the representative measurement point from among the remaining measurement points excluding the measurement point corresponding to the three-dimensional object from the plurality of measurement points, estimates the absolute moving speed of the subject vehicle 101, based on the position information and the speed information of the representative measurement point that has been extracted from the point cloud data acquired by the data acquisition unit 111, and acquires an estimation result as the second speed information. However, the speed acquisition unit may acquire, as the second speed information, the measurement result of the absolute moving speed of the subject vehicle 101 that has been acquired by a measuring instrument included in the internal sensor group 3. In this case, the object detection apparatus 50 includes at least a vehicle speed sensor of the internal sensor group 3, as the measuring instrument. In addition, the speed acquisition unit may calculate and acquire the absolute moving speed of the subject vehicle 101, based on the current position of the subject vehicle 101 that has been measured by the position measurement unit 2. In this case, the object detection apparatus 50 includes the position measurement unit 2.

In addition, in the above embodiment, the detection unit 116 performs the predetermined clustering processing on the three-dimensional point cloud data (the moving point cloud data and the change point cloud data), and detects the moving object from the three-dimensional point cloud data. However, the detection unit may project each measurement point corresponding to the three-dimensional point cloud data on the XY plane to be converted into two-dimensional point cloud data, may generate speed added data (XYV data) obtained by adding the absolute moving speed of each measurement point that has been calculated by the speed calculation unit 113 to the two-dimensional point cloud data, and may perform the predetermined clustering processing on the speed added data. Accordingly, the clustering processing in consideration of the position and the moving speed of the moving object is performed. As a result, it becomes possible to suppress the detection of a plurality of moving objects in close proximity to each other, such as two moving objects that pass each other, as an integrated object (as one moving object), so that the detection accuracy of the moving object can be further improved. Note that in a case where the accuracy of the cluster size in the three-dimensional space (XYZ space) is demanded, the detection unit may generate speed added data (XYZV data) obtained by adding the absolute moving speed of each measurement point that has been calculated by the speed calculation unit 113 to the three-dimensional point cloud data, and may perform the predetermined clustering processing on the speed added data.

In addition, in the above embodiment, the estimation unit 112, which serves as the information acquisition unit, acquires the azimuth angle difference and the moving vector of the subject vehicle 101, as the first moving information indicating the moving state of the subject vehicle 101 from the past time to the current time. However, the information acquisition unit may acquire any other information as the first moving information. Further, in the above embodiment, the memory unit 12 stores the moving vector of the moving object as the second moving information indicating the moving state of the moving object from the past time to the current time. However, the second moving information may be any other information.

In addition, in the above embodiment, the estimation unit 112, which serves as the information acquisition unit, aligns the stationary point cloud data (FIG. 5A) of the previous frame with the stationary point cloud data (FIG. 5B) of the current frame, and estimates the azimuth angle difference and the moving vector of the subject vehicle 101 for a predetermined period of time (between the frames). However, after converting the three-dimensional stationary point cloud data into two-dimensional stationary point cloud data represented in an XY coordinate system, the information acquisition unit may align the data as described above. Further, the information acquisition unit may align the data as described above by using not only the stationary point cloud data of the past time (time t1) but also the stationary point cloud data of a plurality of past times, that is, by using not only the stationary point cloud data of the previous frame but also the stationary point cloud data of the plurality of past frames. In this manner, by using the stationary point cloud data of the plurality of past frames, it becomes possible to align the data as described above satisfactorily even when the stationary object on a forward side of the subject vehicle 101 is temporarily shielded by another vehicle or the like, so that the robustness can be improved.

Further, in the above embodiment, the driving control unit 119 conducts the travel control of the subject vehicle 101 to avoid collision or contact with the object that has been detected by the detection unit 116. However, the driving control unit 119, which serves as a notification unit, may predict a possibility of collision or contact with the moving object, based on the size, the position, and the moving speed of the moving object that has been detected by the detection unit 116. Then, in a case where the possibility of collision or contact with the moving object is equal to or higher than a predetermined degree, an occupant of the subject vehicle 101 may be notified of information (video information or audio information) for calling for attention about collision or contact with the moving object that has been detected by the detection unit 116 via a display or a speaker, not illustrated, included in the vehicle control apparatus 100.

Furthermore, in the above embodiment, the object detection apparatus 50 is applied to a self-driving vehicle, but the object detection apparatus 50 is also applicable to vehicles other than self-driving vehicles. For example, the object detection apparatus 50 is also applicable to a manual driving vehicle including advanced driver-assistance systems (ADAS).

The above embodiment can be combined as desired with one or more of the above modifications. The modifications can also be combined with one another.

According to the present invention, it becomes possible to accurately detect the moving object, while reducing a processing load.

Above, while the present invention has been described with reference to the preferred embodiments thereof, it will be understood, by those skilled in the art, that various changes and modifications may be made thereto without departing from the scope of the appended claims.

What is claimed is:

1. An object detection apparatus comprising:
a detector mounted on a mobile body and configured to irradiate a surrounding of the mobile body with an electromagnetic wave to detect an exterior environment situation in the surrounding of the mobile body based on a reflected wave; and
a microprocessor, wherein
the microprocessor is configured to perform:
acquiring point cloud data for every predetermined period of time, the point cloud data indicating a detection result of the detector, the point cloud data including position information of a measurement point on a surface of an object from which the reflected wave is obtained and first speed information indicating a relative moving speed of the measurement point;
acquiring second speed information indicating an absolute moving speed of the mobile body;
calculating the absolute moving speed of each of a plurality of measurement points corresponding to the point cloud data, based on the first speed information and the second speed information;
classifying the point cloud data into moving point cloud data and stationary point cloud data other than the moving point cloud data, the moving point cloud data corresponding to measurement points where absolute values of the absolute moving speeds are equal to or higher than a predetermined speed;
calculating a moved amount for the predetermined period of time of the stationary point cloud data;
extracting, from the stationary point cloud data, change point cloud data corresponding to measurement points, the moved amount of which are equal to or larger than a predetermined threshold; and
detecting the object in the surrounding of the moving body, based on the moving point cloud data and the change point cloud data.

2. The object detection apparatus according to claim 1, wherein
the microprocessor is configured to perform
the detecting including performing a predetermined clustering processing on the moving point cloud data and the change point cloud data to detect a circumscribed region of the object from each of the moving point cloud data and the change point cloud data, and detecting a position and a size of the object, based on a position and a size of the circumscribed region.

3. The object detection apparatus according to claim 2, wherein
the position information is a three-dimensional position information, and
the microprocessor is configured to perform
the detecting including converting the three-dimensional position information of each of measurement points corresponding to the moving point cloud data and the change point cloud data into two-dimensional position information, generating speed added data by adding the absolute moving speed corresponding to each of the measurement points to the two-dimensional position information of each of the measurement points, and performing the predetermined clustering processing on the speed added data.

4. The object detection apparatus according to claim 2 further comprising
a memory coupled to the microprocessor, wherein
the microprocessor is configured to further perform
acquiring first moving information indicating a moving state of the moving body from a past time before a current time to the current time, based on the stationary point cloud data at the current time and the stationary point cloud data at the past time;
the memory is configured to store second moving information indicating a moving state of the object from the past time to the current time;
the microprocessor is configured to further perform
making alignment of a first circumscribed region detected from the moving point cloud data and the change point cloud data at the past time, based on the first moving information acquired and the second moving information stored in the memory, to be superimposed on a second circumscribed region detected from the moving point cloud data and the change point cloud data at the current time;
determining whether the object corresponding to the first circumscribed region and the object corresponding to the second circumscribed region are identical objects, based on an overlap degree between the first circumscribed region and the second circumscribed region after the alignment; and
updating, based on positions of the first circumscribed region and the second circumscribed region, the second moving information being stored in the memory and corresponding to the objects determined to be the identical objects.

5. The object detection apparatus according to claim 1, wherein
the microprocessor is configured to perform
the acquiring the second speed information including estimating the absolute moving speed of the mobile body, based on the position information and the first speed information of a representative measurement point extracted from the point cloud data acquired by the detector, and acquiring a result of the estimating as the second speed information, and
the representative measurement point is selected from remaining measurement points excluding measurement points corresponding to a three-dimensional object from the plurality of measurement points.

6. The object detection apparatus according to claim 1, further comprising
a measuring instrument configured to measure the absolute moving speed of the mobile body, wherein
the microprocessor is configured to perform
the acquiring the second speed information including acquiring a measurement result of the measuring instrument as the second speed information.

7. The object detection apparatus according to claim 1, wherein
the detector is a Lidar.
